(19) United States
(12) Patent Application Publication
(10) Pub. No.: US 2010/0017636 A1
(43) Pub. Date: Jan. 21, 2010

(54) POWER SUPPLY SYSTEM

(75) Inventors: Takayuki Hashimoto, Tokai (JP); Masaki Shiraishi, Hitachinaka (JP); Noboru Akiyama, Hitachinaka (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/517,939

(22) PCT Filed: Nov. 21, 2007
(86) PCT No.: PCT/JP2007/072580

§ 371 Date: Jun. 5, 2009

(30) Foreign Application Priority Data
Dec. 7, 2006 (JP) 2006-330147

(51) Int. Cl. G06F 1/32; G06F 1/04; H02M 3/155

(52) U.S. Cl. 713/322

(57) ABSTRACT

In a power supply system having: a processor 1; a power supply controller 31 and a VR 35 to be a switching regulator for supplying power to the processor; a voltage command generator 11 and a clock command generator 16 for varying an operation voltage and a clock frequency of a processor core of the processor; and a battery 34 to be an input direct-current voltage source of the switching regulator, the clock frequency of the power supply controller 31 is lowered when the computation amount of the processor 1 is small. Accordingly, the loss of the power supply controller 31 is reduced, thereby extending the battery life in the electronic device.

### TECHNICAL FIELD

The present invention relates to a control technique of power supply and is used for electronic devices such as a personal computer, and more particularly, it relates to a technique effectively applied to a power supply system which is characterized by a control method of power supply for a processor.

### BACKGROUND ART

A recent processor which is used for electronic devices such as a personal computer has further achieved a high performance, and a processing speed and power consumption of the processor have also increased with this high performance, and therefore, a heat-generation amount of the processor and power consumption of a drive battery have also increased.

In consideration of these factors, means that the processor power consumption is controlled by varying a clock frequency and a core voltage of the processor is taken in conventional electronic devices. FIG. 14 shows a block diagram of a power system for a processor of a comparative technique to the present invention which the inventors have studied. Only units related to an operation voltage and a clock frequency are shown in a processor 1, and specifically, the units are a processor core 12, an arithmetic amount determiner 13, and a clock command generator 16 calculating a clock frequency of the processor core 12 and outputting a command value to generate a desired clock frequency by a multiplier 15. The processor 1 operates in synchronization with a bus controller 2, and a clock frequency of the processor 1 is generated by multiplying a frequency of a system clock 22 at the multiplier 15. The above-said processor core 12 is a circuit block combined with an instruction generator, a computing unit, and others in the processor 1 for assuming a role of data process.

Normally, a frequency band of about 600 MHz to 1 GHz is used for the frequency of the system clock 22 in a personal computer, and an output of the multiplier 15, that is the clock frequency of the processor core 12, is about 200 MHz to 3 GHz. The bus controller 2 mediates data between the processor 1 and an external storage device such as an external memory 23 and an HDD 24, an output device such as a graphic 25, and an input/output device such as a BIOS 26. A data transfer path 27 is a data path between the processor 1 and the bus controller 2, and a data transfer path 28 is a data path to the external devices, and both paths have two-way direction.

Regarding a power supply which supplies power to the processor core 12, a voltage command value is transmitted from a voltage command generator 11 to a power supply controller 31 depending on an arithmetic amount of the processor core 12 so that a desired voltage is supplied to the processor 1 via a VR (Voltage Regulator) 35. The power supply controller 31 monitors an output voltage of the VR 35 and controls so as to match a target value from the voltage command generator 11 and a value of a voltage feedback 38.

There is a power supply 3 as a factor which determines an operation voltage of the processor core 12, and a power supply managing part 32 varies the operation voltage of the processor core 12 depending on whether the power supply 3 is either an AC adaptor 33 or a battery 34. For example, when the power supply 3 is the battery 34, the operation voltage of the processor core 12 is lowered compared to the AC adaptor 33. This is for reducing power consumption by sacrificing a process speed of the processor 1 in order to extend the battery life. On the other hand, when the AC adaptor 33 is connected as the power supply 3, the operation voltage is set to be higher than the battery 34 for giving a priority to the process speed of the processor 1. A power transfer path 36 depicts a transfer of the power from the power supply 3 to the VR 35, and a power transferring path 37 depicts a transfer of the power from the VR 35 to the processor core 12.

Next, a configuration of the VR 35 will be described with reference to FIG. 15. In FIG. 15, an inside of a dotted line corresponds to the VR 35, and there are an input capacitor Cin, the power supply controller 31, a driver 43, a high-side MOSFET (QH1), a low-side MOSFET (QL1), an output inductance L, and an output capacitor Cout as components. A direct-current power supply Vin for an input of a MOSFET is an output of the AC adaptor 33 or the battery 34 in FIG. 14. The processor 1 is connected to the output capacitor Cout in parallel. Regarding a circuit operation of the VR 35, a gate GH of the high-side MOSFET (QH1) is driven in synchronization with a PWM signal outputted from the power supply controller 31, and a gate GL of the low-side MOSFET (QL1) is driven in reverse phase with this signal. A frequency of a PWM signal is called a switching frequency because a switching operation of ON and OFF is performed with a same cycle with the PWM signal by the high-side MOSFET (QH1) and the low-side MOSFET (QL1) which are switching elements. The PWM is an abbreviation of Pulse Width Modulation whose switching frequency is constant and which controls an output voltage by setting a pulse width of the PWM signal to be variable. A weak point of the PWM control is lowering of power efficiency due to a large loss caused by the switching when a current consumption of a processor to be a load is small. As a method for solving the weak point, a method which switches from PWM to PFM (Pulse Frequency Modulation) when the current consumption of the processor is small is known. The PFM is a control method which lowers the switching frequency in a region having small power consumption, and the method can make the loss caused by the switching small.

Next, with reference to FIGS. 16A and 16B, a relation between a computation amount of the processor and FIG. 16A: the operation voltage of the core, FIG. 16B: the clock frequency of the core will be described. Here, although a horizontal axis shows the computation amount, the horizontal axis can be also the power consumption of the processor core because the current consumption of the core is large when the computation amount of the core is large. As seen from the graphs of FIG. 16A and FIG. 16B, when the computation amount of the processor core becomes larger, the operation voltage and the clock frequency of the core become higher. This is a method called FV control (Frequency-Voltage control) in which the clock frequency and the operation voltage increase when the computation amount of the processor core increases, so that the loss and the heat-generation amount increase. When the loss is referred to as “P”, the clock frequency is referred to as “f”, total output capacitance of the transistor is referred to as “C”, and the operation voltage is referred to as “V”, the loss P can be expressed by P=f×CV²/2, and it is found in the expression that the loss P also increases when the clock frequency f and the operation voltage V increase. On the contrary, the operation voltage and the clock frequency of the processor core are actively lowered when the computation amount is small so that the power consumption can be reduced.

### DISCLOSURE OF THE INVENTION

### Problems to be Solved by the Invention

As described above, there are the following two techniques for improving the power efficiency of an electronic device when the arithmetic amount of the processor is small.

(1) For reducing the switching loss of the VR, the switching frequency is lowered when the current consumption of the processor, that is an output current of the VR, is small.

(2) For reducing the loss of the processor, the operation voltage and the clock frequency of the processor core are lowered when the computation amount of the processor is small.

As a reason that the power efficiency is important when the computation amount of the processor is small, a life of the battery-powered electronic device such as a mobile personal computer is cited. For example, in a mobile personal computer for an individual user, since 90% or more of use time is in a state that the arithmetic amount of the processor is small, it is effective for achieving long life of the battery to reduce the loss in the region having the small computation amount.

As described above, a loss of the power supply controller becomes relatively large as the result of the reduced losses of the processor and the VR in the region having the small computation amount of the processor, and thus the loss of the power supply controller is one of main factors for determining the battery life. In recent years, as another reason that makes the loss of the power supply controller large, digitalization for the power supply control is cited. Although analog was conventionally the mainstream for the power supply control, the digital control with high performance is required, and also, it has been easier to get a digital IC with a low cost, and therefore, the digital control having a lot of advantages has been seriously studied. While an achievement of a clock with a high frequency is effective for the achievement of the digital control with high performance, the achievement brings a problem that the loss of the digital controller becomes large.

As described above, an issue of the comparative technique to the present invention is a short life of the battery of the electronic device due to the large loss of the power supply controller in a condition that the computation amount of the processor is small.

Accordingly, an object of the present invention is to solve this issue in order to provide a power supply system in which the loss of the power supply controller is reduced by lowering the clock frequency of the power supply controller when the computation amount of the processor is small so that the battery life of the electronic device can be extended.

The above and other objects and novel characteristics of the present invention will be apparent from the description of this specification and the accompanying drawings.

### Means for Solving the Problems

The typical ones of the inventions disclosed in the present application will be briefly described as follows.

For achieving the above-described object, the present invention is applied to a power supply system including: a processor; a switching regulator for supplying power to the processor; means for varying an operation voltage and a clock frequency of a processor core in the processor; and a battery to be an input direct-current voltage supply to the switching regulator, and the switching regulator includes: a power supply controller for generating ON/OFF signal of the switching from at least 2 or more input values including a command value and a detection value of the operation voltage of the processor core; and a voltage regulator for converting the input direct-current voltage supply into a constant voltage upon receiving an output signal of the power supply controller and supplying power to the processor, wherein, the power supply system is for lowering the clock frequency of the power supply controller when the calculation amount of the processor is small. In this manner, the loss of the power supply controller is reduced, so that the battery life of the electronic device can be extended.

### EFFECTS OF THE INVENTION

The effects obtained by typical aspects of the present invention will be briefly described below.

According to the present invention, there is an effect to improve the power efficiency of the power supply system by lowering the clock frequency of the power supply controller when the computation amount of the processor is small. As a result, the power efficiency is improved, thereby being capable of extending the life of the electronic device having the battery as the power supply.

### BRIEF DESCRIPTIONS OF THE DRAWINGS

FIG. 1 is a block diagram showing a power supply system according to a first embodiment of the present invention;

FIG. 2 is a diagram showing a relation between a computation amount of a processor core and a clock frequency of a power supply controller according to the first embodiment of the present invention;

FIG. 3 is a diagram showing a comparison of the present invention and a comparative technique related to the power efficiency according to the first embodiment of the present invention;

FIG. 4A and FIG. 4B are diagrams showing a comparison of the present invention (FIG. 4B) and the comparative technique (FIG. 4A) related to a loss component according to the first embodiment of the present invention;

FIG. 5 is a block diagram showing a power supply system according to a second embodiment of the present invention;

FIG. 6 is a block diagram showing a power supply system according to a third embodiment of the present invention;

FIG. 7 is a block diagram showing a power supply system according to a fourth embodiment of the present invention;

FIG. 8 is a block diagram showing a power supply system according to a fifth embodiment of the present invention;

FIG. 9 is a block diagram showing a power supply system according to a sixth embodiment of the present invention;

FIG. 10 is a block diagram showing a power supply system according to a seventh embodiment of the present invention;

FIG. 11 is a block diagram showing a power supply system according to an eighth embodiment of the present invention;

FIG. 12 is a block diagram showing a power supply system according to a ninth embodiment of the present invention;

FIG. 13 is a diagram showing a relation between an arithmetic amount of a processor core and a switching frequency of a VR according to the ninth embodiment of the present invention;

FIG. 14 is a block diagram showing the power supply system in the comparative technique with respect to the present invention;

FIG. 15 is a circuit diagram showing a VR in the comparative technique with respect to the present invention;

FIGS. 16A and 16B are diagrams where FIG. 16A shows a relation between the computation amount of the processor core and an operation voltage and FIG. 16B shows a relation between the computation amount of the processor core and a clock frequency in the comparative technique compared to the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

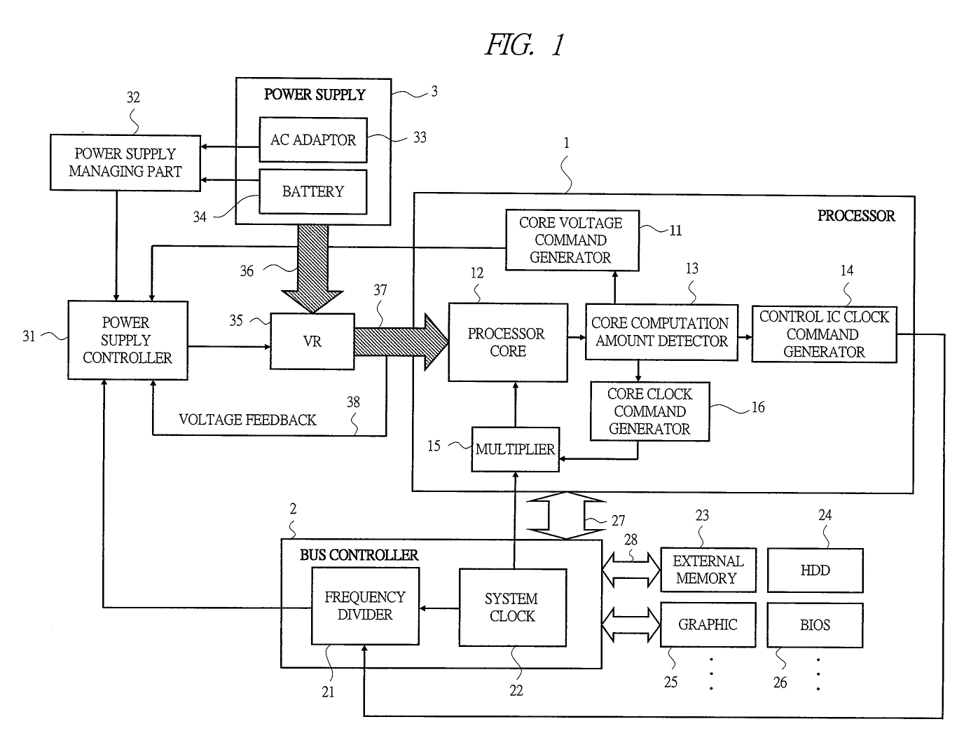

FIG. 1 is a block diagram showing a power supply system according to a first embodiment of the present invention, and only blocks related to an operation voltage and a clock frequency are shown in a processor 1.

The power supply system according to the present embodiment is configured with the processor 1, a bus controller 2, a power supply 3, and others.

The processor 1 includes a processor core 12, an computation amount detector 13 of the processor core 12, a voltage command generator 11 of the processor core 12, a clock command generator 16 of the processor core 12, a multiplier 15, a clock command generator 14 of a control IC, and others, and the operation voltage and the clock frequency of the processor core 12 are determined depending on the computation amount. The power consumption is saved by lowering the operation voltage and the clock frequency when the computation amount is small, and the process speed is increased by increasing the operation voltage and the clock frequency when the computation amount is large.

The bus controller 2 mediates data among the processor 1 and an external storage device such as an external memory 23 and an HDD 24, an output device such as a graphic 25, and an input/output device such as a BIOS 26. Regarding means which supply power to the processor 1, a power supply controller 31 controls a VR (Voltage Regulator) 35 based on a voltage command from the processor 1 to output a desired voltage to the processor 1.

There are an AC adaptor 33 and a battery 34 to be an input direct-current voltage supply as the power supply 3, and a power supply managing part 32 detects a connection of either the AC adaptor 33 or the battery 34 or both of them, and notice it to the power supply controller 31.

In this power supply system, the power supply controller 31, the VR 35, and others are included as a switching regulator for supplying power to the processor 1. The power supply controller 31 has a function of generating ON/OFF signals of the switching from at least 2 or more input values including a command value and a detection value of the operation voltage of the processor core 12. The VR 35 has a function of and converting an input direct-current voltage supply into a constant voltage upon receiving an output signal of the power supply controller 31 and supplying power to the processor 1. The voltage command generator 11, the clock command generator 16, and others function as means for varying the operation voltage and the clock frequency of the processor core 12.

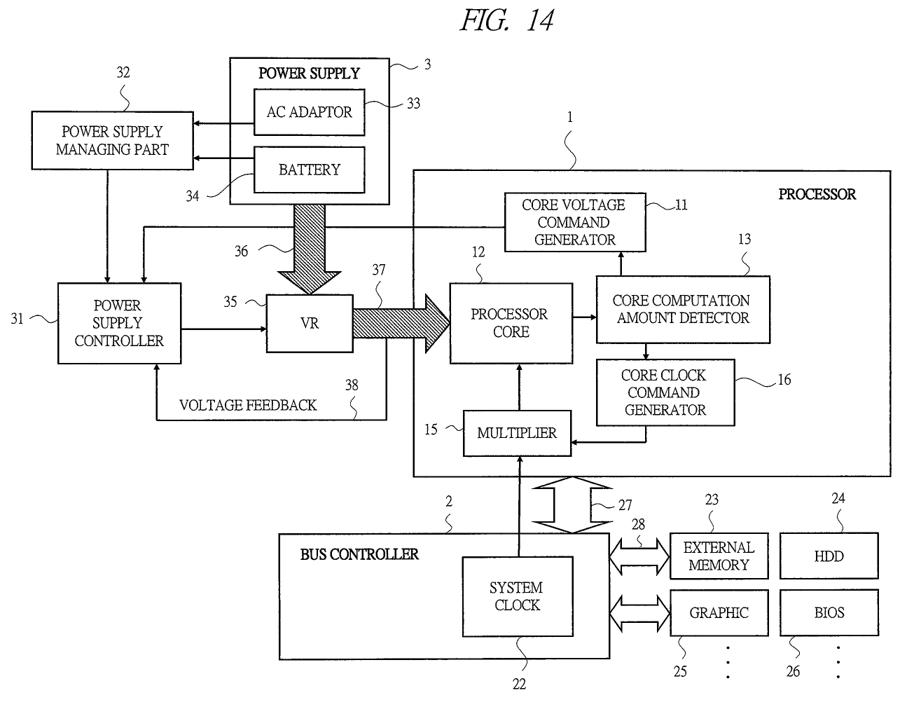

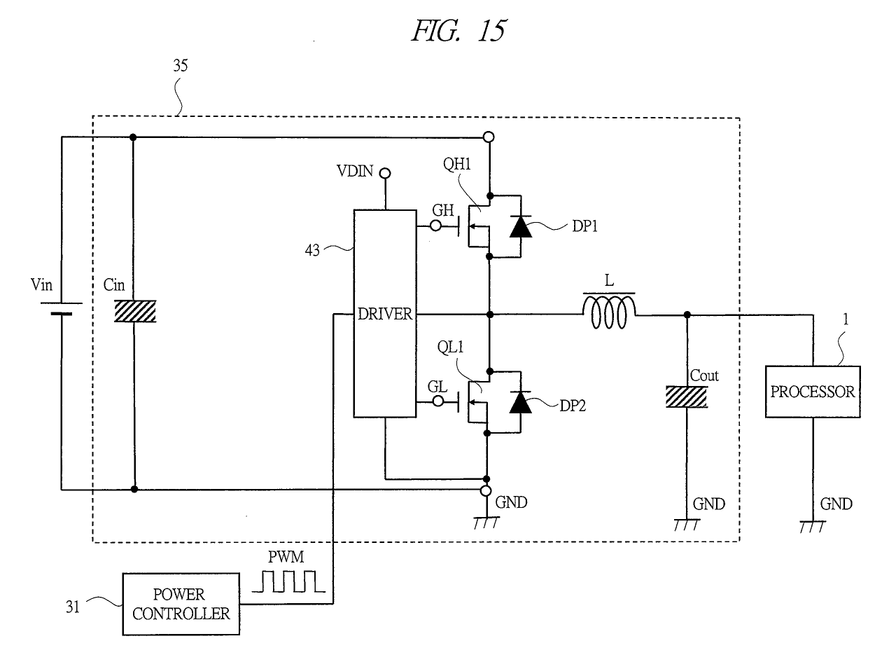

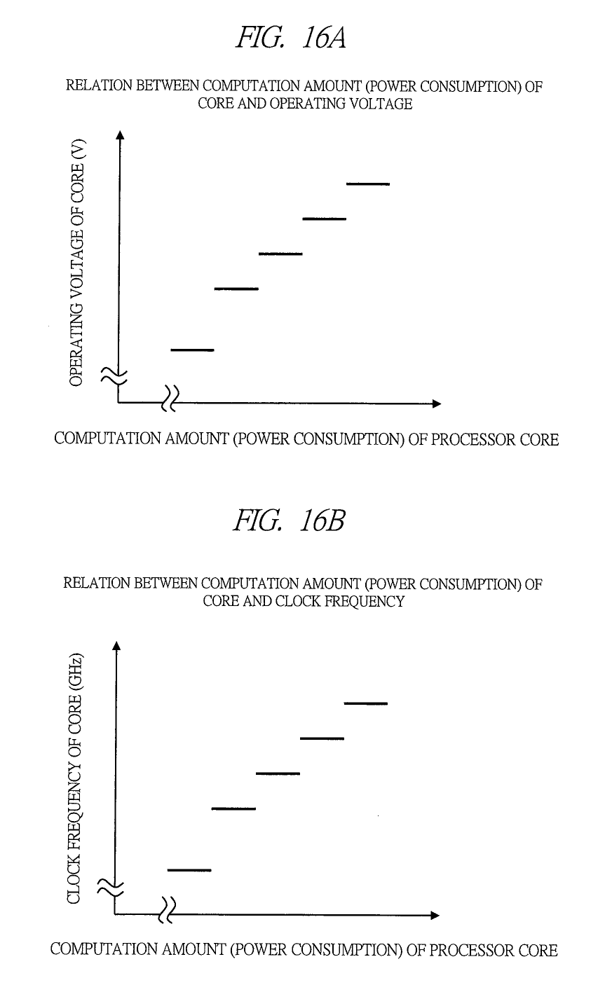

More particularly, in the power supply system of the present embodiment, a different point of the present invention shown in FIG. 14 from the comparative technique is to include: the computation amount detector 13 for detecting the computation amount of the processor core 12; the clock command generator 14 for outputting the command value of the clock frequency of the power supply controller 31 from the detection value of the computation amount; and a frequency divider 21 for generating the clock frequency of the power supply controller 31 upon receiving the command value, and is to detect the computation amount of the processor core 12 in the computation amount detector 13 and vary the clock frequency of the power supply controller 31 by controlling the frequency divider 21.

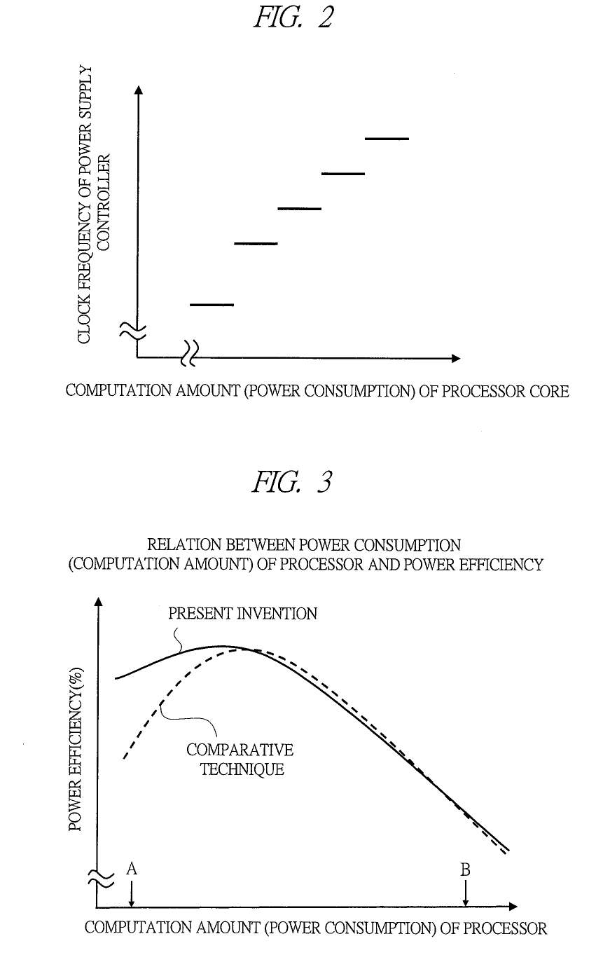

Specifically, the clock frequency of the power supply controller 31 is lowered when the computation amount of the processor core 12 is small, thereby reducing the loss in the low power consumption mode. FIG. 2 shows the relation between the computation amount of the processor core and the clock frequency of the power supply controller according to the present embodiment, in which the clock frequency of the power supply controller is low when the computation amount of the processor core is small. Since there is a correlation between the computation amount of the processor core and the power consumption of the processor core, the horizontal axis can be also the power consumption of the processor core. That is, there is a correlation that the power consumption also decreases as the computation amount of the processor core is small.

FIG. 3 shows a characteristics comparison of the present embodiment (present invention) and the comparative technique, and the computation amount of the processor is taken on a horizontal axis, and the power efficiency of the electronic device is taken on a vertical axis. The power of the electronic device includes the processor, the VR, and the power supply controller. Normally, while the power of the electronic device also includes a display device such as a display, an input device such as a mouse, and a storage device such as an HDD, the power of the electronic device has been defined as described above since the present invention targets the processor and the power supply system which supplies power to the processor.

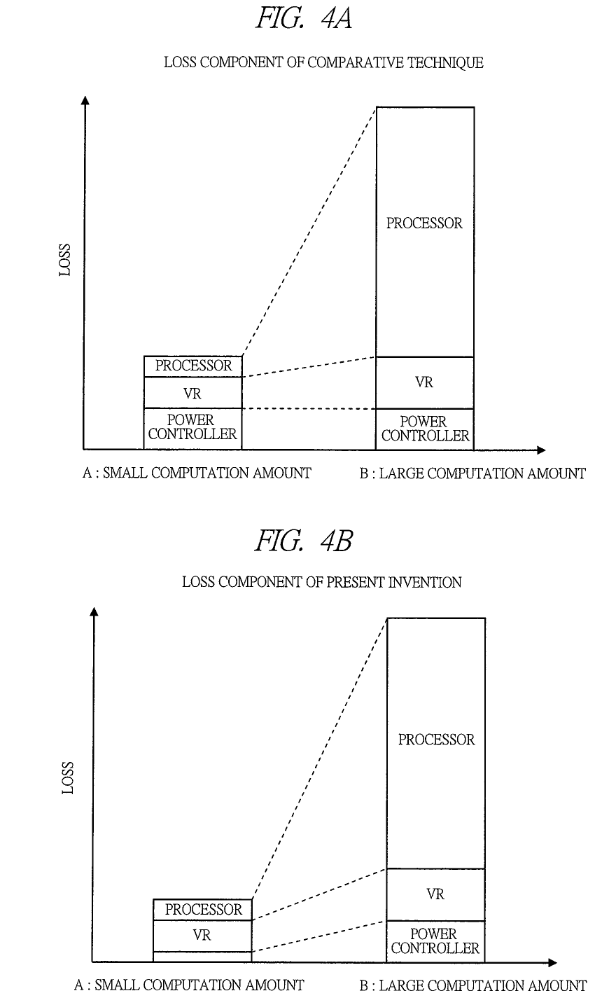

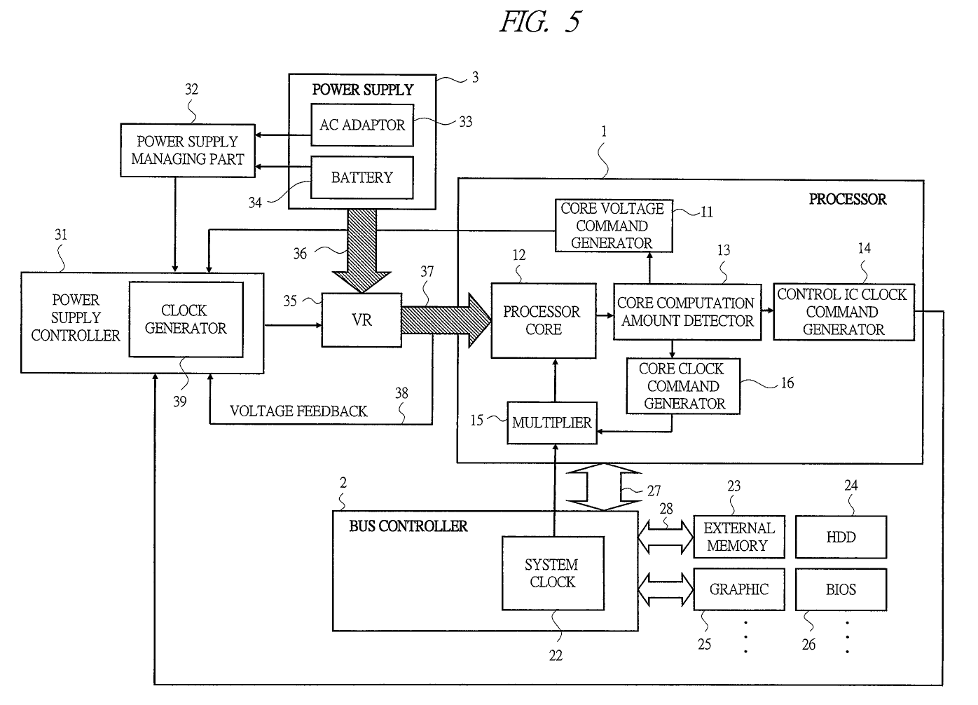

In FIG. 3, as compared with the power efficiency in the comparative technique decreasing as the computation amount becomes small, the decrease of the power efficiency in the present invention is small. A reason for that will be described with reference to FIG. 4. FIG. 4A and FIG. 4B show loss components at “A” point (small computation amount) and “B” point (large computation amount) in FIG. 3 of FIG. 4A: the comparative technique and FIG. 4B: the present invention, respectively. And, in FIG. 4A: the comparative technique, it is found that the loss of the processor largely decreases when the computation amount becomes small (B→A). This is because the processor detects the computation amount and controls the operation voltage and the clock frequency as described above. Also regarding the VR, the loss decreases when the arithmetic amount of the processor core becomes small (B→A). This is because an output current of the VR decreases with the decrease of the computation amount of the processor core, so that the caused loss becomes small. In addition, depending on the power supply controller, provided is a function of so-called PWM/PFM control which lowers the frequency when the output current of the VR is small as described above, and it also becomes a reason for the loss reduction.

On the other hand, regarding the power supply controller, the loss does not decrease even when the computation amount of the processor core decreases (B→A). In the comparative technique, since the clock frequency of the power supply controller is constant regardless of the computation amount of the processor, the loss of the power supply controller does not decrease.

In FIG. 4B: the present invention, compared to FIG. 4A: the comparative technique, when the computation amount of the processor is small, the losses of not only the processor and the VR but also the power supply controller decrease. This is because the clock frequency of the power supply controller is lowered when the computation amount of the processor is small, so that the loss of the power supply controller is reduced.

In the manner of the foregoing, according to the power supply system of the present embodiment, since the computation amount detector 13, the clock command generator 14, the frequency divider 21, and others are provided, the clock frequency of the power supply controller 31 is lowered when the computation amount of the processor core 12, which is the processor 1, is small so that the loss of the power supply controller 31 is reduced, thereby improving the power efficiency of the power supply system. Since the power efficiency is improved as a result, the life of the battery 34 is extended, so that the life of the electronic device having the battery 34 as the power source can be extended.

### Second Embodiment

Next, a power supply system according to a second embodiment of the present invention will be described with reference to FIG. 5. A different point of the present embodiment from the first embodiment is to include a clock generator 39 inside of the power supply controller 31. While the clock of the power supply controller 31 is generated from the system clock via the frequency divider in the first embodiment, the clock is generated in the clock generator 39 inside of the power supply controller 31 upon receiving a clock command of the power supply controller transmitted from the processor 1 in the present embodiment.

Therefore, also in the power supply system of the present embodiment, the clock frequency of the power supply controller 31 is lowered when the computation amount of the processor 1 is small similarly to the first embodiment by having the computation amount detector 13, the clock command generator 14, the clock generator 39, and others, so that the power efficiency of the power supply system is improved, and as a result, the life of the electronic device having the battery 34 as the power source can be extended.

### Third Embodiment

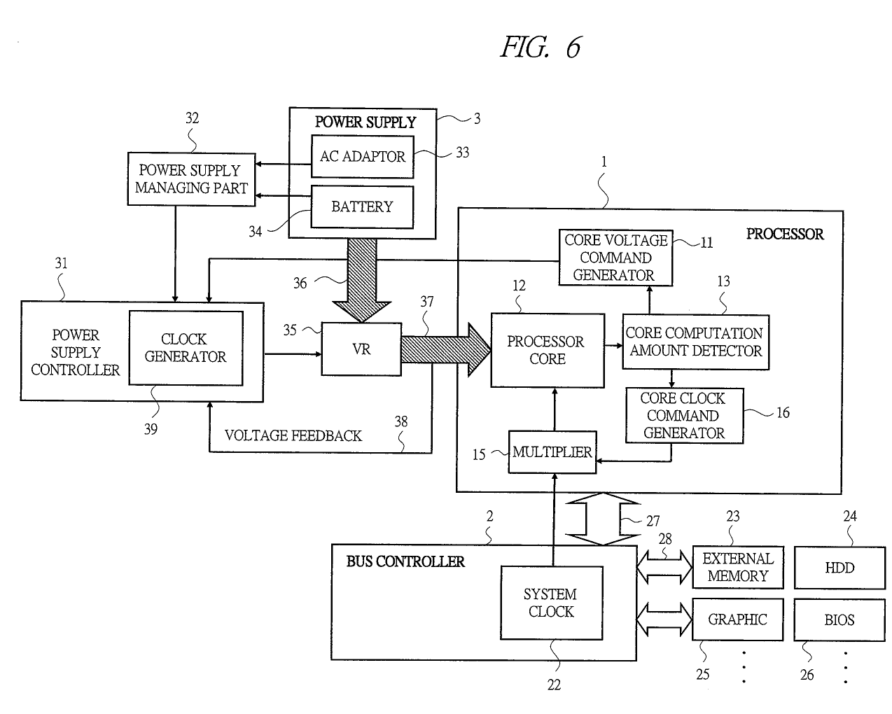

Next, a power supply system according to a third embodiment of the present invention will be described with reference to FIG. 6. A different point of the embodiment from the first embodiment is to generate the clock in the clock generator 39 inside of the power supply controller 31 by calculating the clock frequency of the power supply controller 31 from a voltage command generator 11 of the processor core 12. As described above, the method of lowering the operation voltage of the processor 1 is used when the computation amount of the processor 1 is small, so that the computation amount is estimated from the operation voltage of the processor 1.

Therefore, in the power supply system of the present embodiment, the clock frequency of the power supply controller 31 is lowered when the operation voltage of the processor 1 is low, so that the power efficiency of the power supply system is improved similarly to the first embodiment by having the computation amount detector 13, the voltage command generator 11, the clock generator 39, and others, and as a result, the life of the electronic device having the battery 34 as the power source can be extended. A superior point of the present embodiment compared to the first embodiment is that a circuit related to the clock of the power supply controller 31 is unnecessary in the processor 1 and the bus controller 2 since the computation amount is estimated from the core voltage of the processor 1.

### Fourth Embodiment

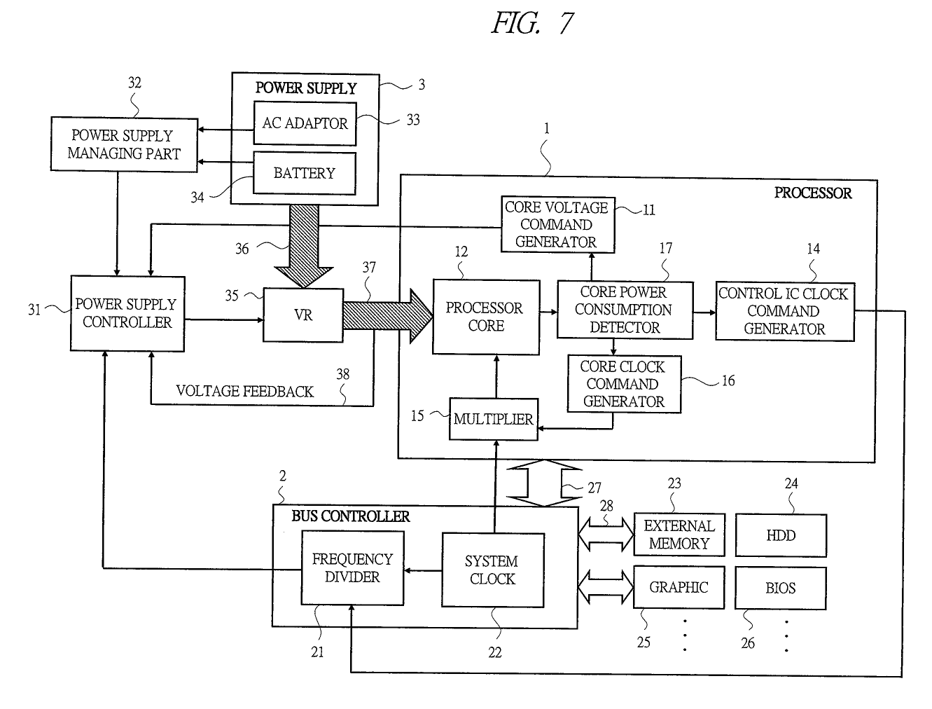

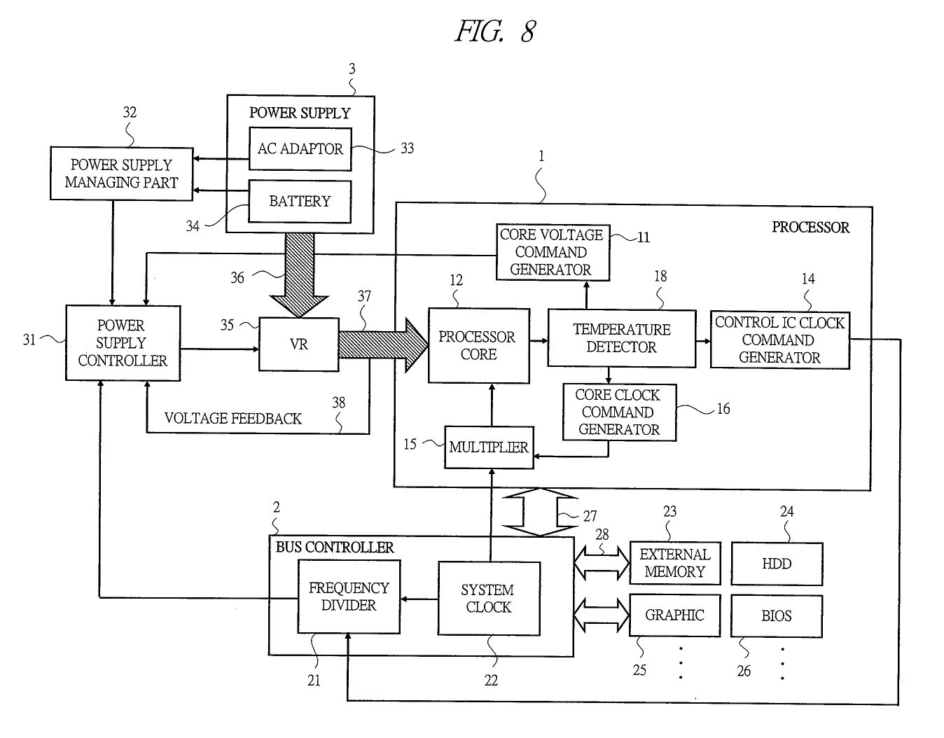

Next, a power supply system according to a fourth embodiment of the present invention will be described with reference to FIG. 7. A different point of the present embodiment from the first embodiment is to detect not the computation amount of the processor 1 but a power consumption of the processor core 12 in a power consumption detector 17. Since the power consumption also increases when the computation amount of the processor 1 increases, the power consumption can be used as a detection value instead of the computation amount.

Therefore, in the power supply system of the present embodiment, the clock frequency of the power supply controller 31 is lowered when the power consumption of the processor 1 is low by having the power consumption detector 17, the clock command generator 14, the frequency divider 21, and others, so that the power efficiency of the power supply system is improved similarly to the first embodiment, and as a result, the life of the electronic device having the battery 34 as the power source can be extended.

### Fifth Embodiment

Next, a power supply system according to a fifth embodiment of the present invention will be described with reference to FIG. 8. A different point of the present embodiment from the first embodiment is to detect not the computation amount of the processor 1 but temperature of the processor core 12 in a temperature detector 18. Since the temperature of the processor core 12 becomes high when the computation amount of the processor 1 increases, the temperature can be used as the detection value instead of the computation amount. As a specific method of the temperature detection, a forward voltage drop of a p-n junction diode embedded in the processor 1 can be used. There is a negative correlation between the forward voltage drop of the p-n junction diode and the temperature, and the higher the temperature is, the smaller the forward voltage drop becomes.

Therefore, in the power supply system of the present embodiment, the clock frequency of the power supply controller 31 is lowered when the temperature of the processor 1 is low by having the temperature detector 18, the clock command generator 14, the frequency divider 21, and others, so that the power efficiency of the power supply system is improved similarly to the first embodiment, and as a result, the life of the electronic device having the battery 34 as the power source can be extended.

### Sixth Embodiment

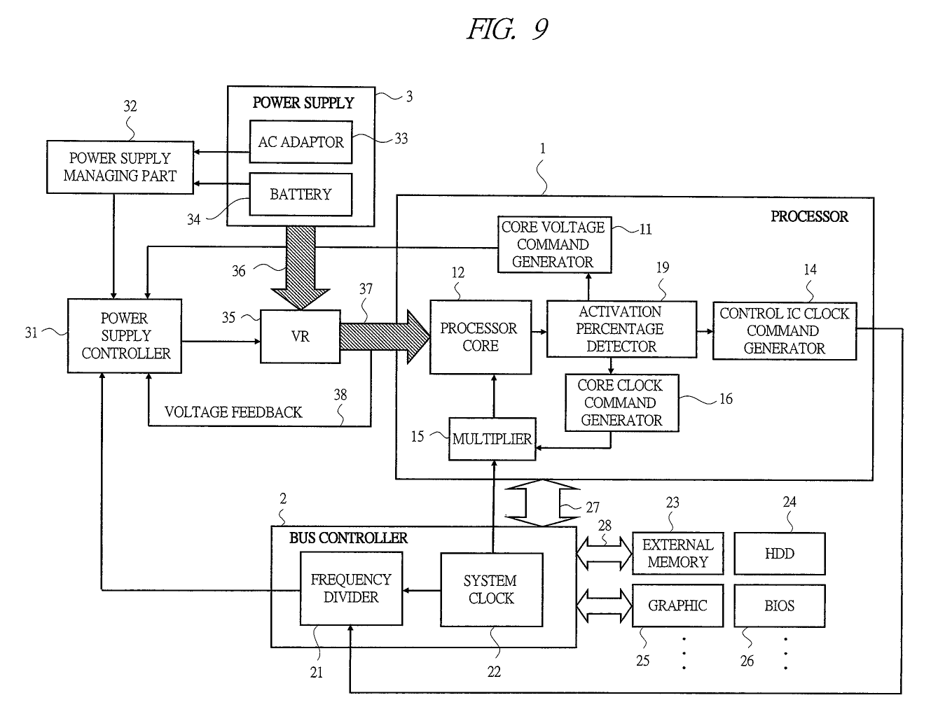

Next, a power supply system according to a sixth embodiment of the present invention will be described with reference to FIG. 9. A different point of the present embodiment from the first embodiment is to detect not the computation amount of the processor 1 but an activation ratio of the processor core 12 in an activation ratio detector 19. Since the activation of the processor core 12 also increases when the computation amount of the processor 1 increases, the activation ratio can be used as the detection value instead of the arithmetic amount. The activation ratio described here is a percentage of active transistors among all transistors. The activation ratio increases when the computation amount is large, and the activation ratio decreases when the computation amount is small.

Therefore, in the power supply system of the present embodiment, the clock frequency of the power supply controller 31 is lowered when the activation ratio of the processor 1 is low by having the activation ratio detector 19, the clock command generator 14, the frequency divider 21, and others, so that the power efficiency of the power supply system is improved similarly to the first embodiment, and as a result, the life of the electronic device having the battery 34 as the power source can be extended.

### Seventh Embodiment

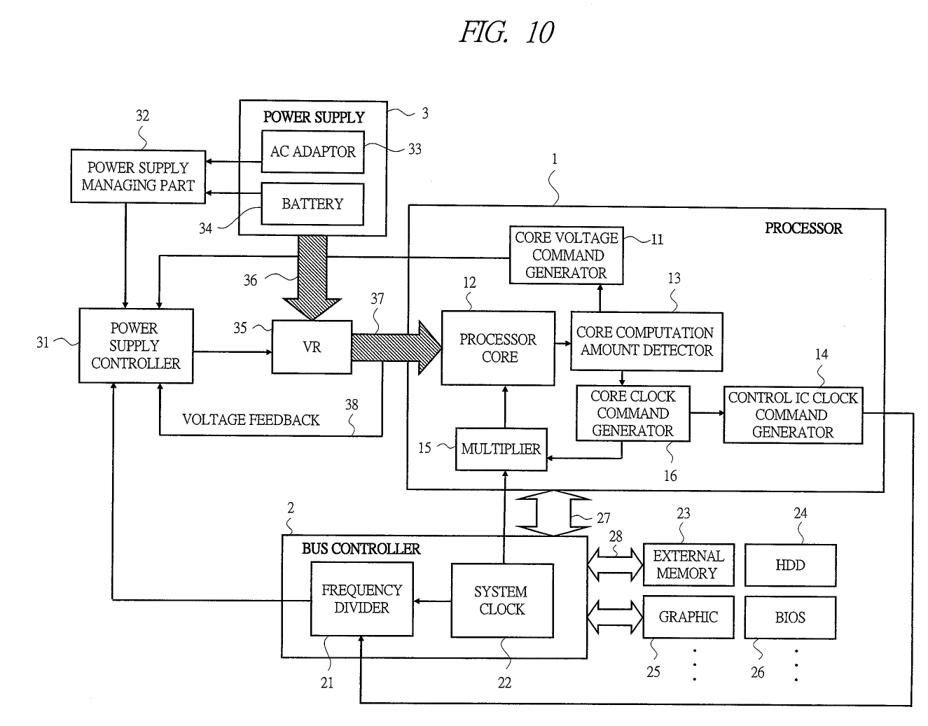

Next, a power supply system according to a seventh embodiment of the present invention will be described with reference to FIG. 10. A different point of the present embodiment from the first embodiment is to detect not the computation amount of the processor 1 but the clock frequency of the processor core 12 in the computation amount detector 13 and the clock command generator 16. Since the clock frequency also increases when the computation amount of the processor 1 increases, the clock frequency can be used as the detection value instead of the computation amount.

Therefore, in the power supply system of the present embodiment, the clock frequency of the power supply controller 31 is lowered when the clock frequency of the processor 1 is low by having the computation amount detector 13, the clock command generator 16 of the processor core 12, the clock command generator 14 of the control IC, the frequency divider 21, and others, so that the power efficiency of the power supply system is improved similarly to the first embodiment, and as a result, the life of the electronic device having the battery 34 as the power source can be extended.

### Eighth Embodiment

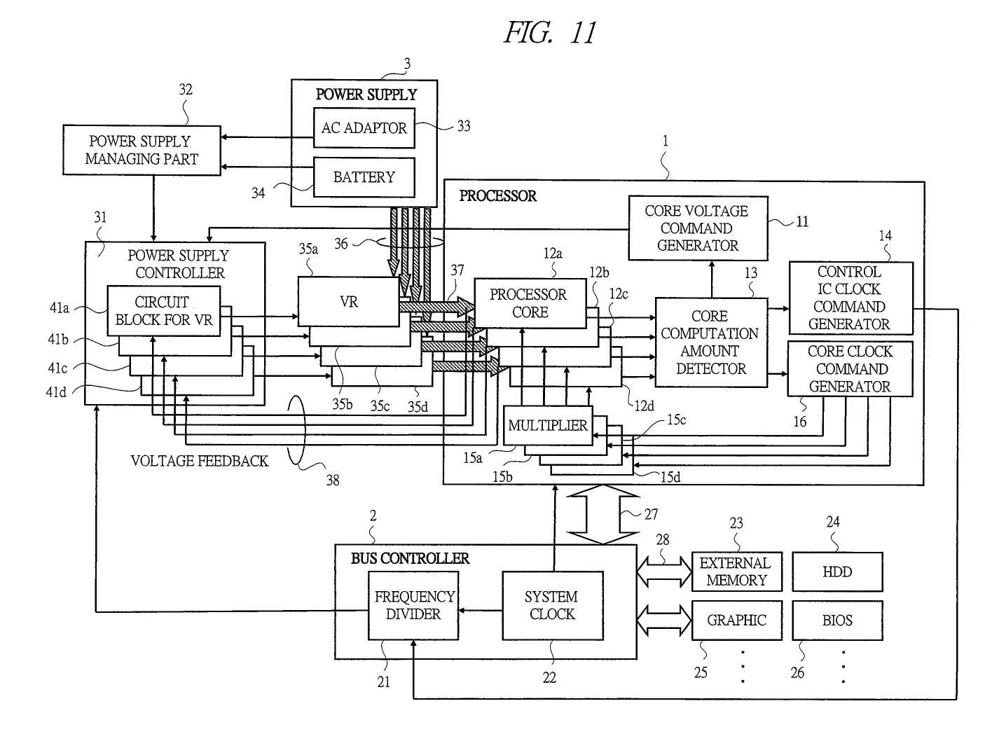

Next, a power supply system according to an eighth embodiment of the present invention will be described with reference to FIG. 11. A different point of the present embodiment from the first embodiment is that the number of cores of the processor 1 is more than one. In FIG. 11, four processor cores 12a, 12b, 12c, and 12d, the same number of multipliers (15a, 15b, 15c, and 15d) as the processor cores, the same number of the VR (35a, 35b, 35c, and 35d) as the processor cores, and the same number of VR control circuit blocks (41a, 41b, 41c, and 41d) of the power supply controller as the processor cores are included.

The clock frequency of the processor core and the switching frequency of the VR become frequencies optimized in each phase. The clock frequency of the processor core having a large computation amount and the switching frequency of the VR are high, and the clock frequency of the processor core having a small arithmetic amount and the switching frequency of the VR are low. On the other hand, the clock frequencies of the power supply controller are same in the inside of the power supply controller, and the clock frequencies depend on a VR having the highest switching frequency. That is, since the clock frequency of the power supply controller is required to be more increased as the switching frequency is higher, the clock frequency of the power supply controller is determined so as to adjust to the VR having the highest switching frequency.

Therefore, in the power supply system of the present embodiment, the computation amount of the processor core having the largest computation amount among the plurality of processor cores is detected in the computation amount detector 13, and the clock frequency of the power supply controller 31 is lowered when the computation amount of the processor core is small by having the computation amount detector 13 of the plurality of processor cores 12a, 12b, 12c, and 12d, the clock command generator 16 of the plurality of processor cores 12a, 12b, 12c, and 12d, the clock command generator 14 of the control IC, the frequency divider 21, and others, so that the power efficiency of the power supply system is improved similarly to the first embodiment, and as a result, the life of the electronic device having the battery 34 as the power source can be extended.

Note that, also in the configuration having the plurality of processor cores as the present embodiment, the operation voltage, the power consumption, the temperature, the activation ratio, and the clock frequency can be used as the detection value instead of the arithmetic amount, similarly to each embodiment described above.

### Ninth Embodiment

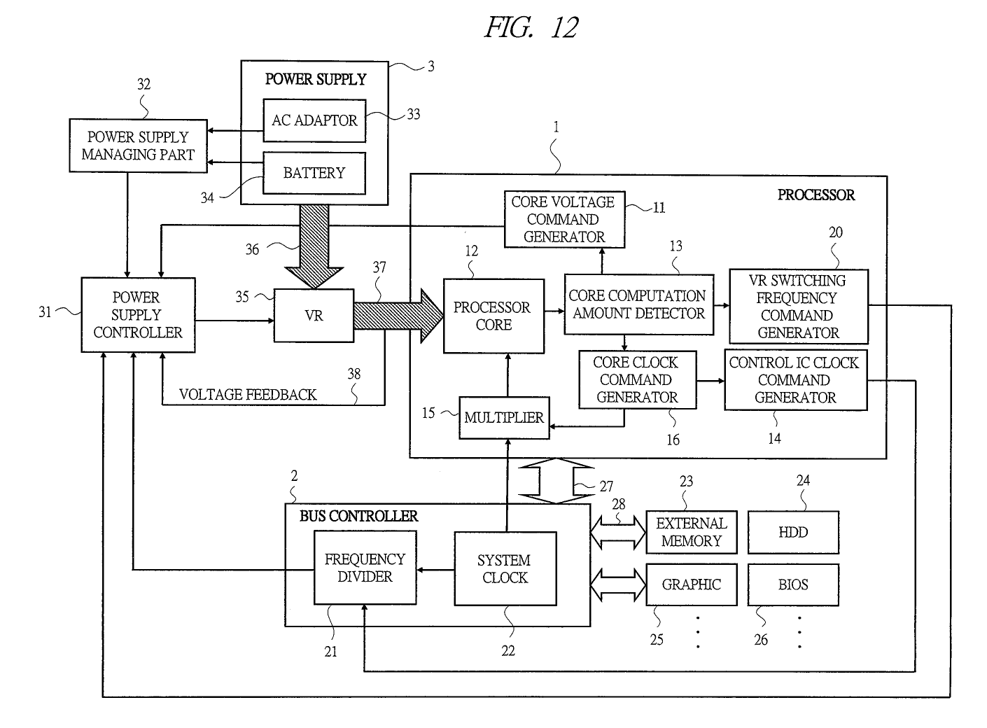

Finally, a power supply system according to a ninth embodiment of the present invention will be described with reference to FIG. 12. A different point of the present embodiment from the first embodiment is to make the switching frequency of the VR 35 also variable in a switching frequency command generator 20 as well as the clock frequency of the power supply controller 31. Conventionally, while there has been a method in which an output current of the VR 35 is detected and make the switching frequency of the VR 35 variable, there has been no method to make the switching frequency of the VR 35 and the clock frequency of the power supply controller 31 variable according to the computation amount of the processor 1.

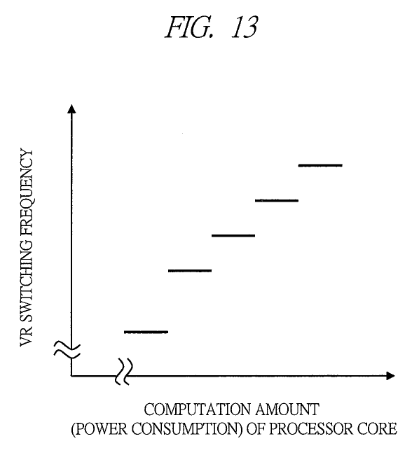

FIG. 13 is a diagram showing a relation between the computation amount (power consumption) of the processor core 12 and the switching frequency of the VR 35 according to the present embodiment, where the switching frequency of the VR 35 is also larger as the arithmetic amount of the processor core 12 is larger.

Therefore, in the power supply system of the present embodiment, the clock frequency of the power supply controller 31 is lowered and the switching frequency of the VR 35 is lowered when the computation amount of the processor 1 is small by having the computation amount detector 13, the switching frequency command generator 20, the clock command generator 16, the frequency divider 21, and others, so that the power efficiency of the power supply system is improved similarly to the first embodiment, and as a result, the life of the electronic device having the battery 34 as the power source can be extended.

While the invention made by the inventors of the present invention has been concretely described based on the embodiments in the foregoing, it is needless to say that the present invention is not limited to the foregoing embodiments and various modifications and alterations can be made within the scope of the present invention.

### INDUSTRIAL APPLICABILITY

The power supply system of the present invention is used for an electronic device such as a personal computer, and more particularly, the power supply system of the present invention can be used for a power supply system having a feature in a control method of a power supply for a processor.

1. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator including:
a power supply controller for generating ON/OFF signals of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, wherein
the power supply system includes:
a computation amount detector for detecting a computation amount of the processor core;
a command generator for outputting a command value of a clock frequency of the power supply controller from a detection value of the computation amount; and
a frequency divider for generating the clock frequency of the power supply controller upon receiving the command value, and
the power supply system controls the frequency divider when a decrease of the computation amount is detected in the computation amount detector to lower the clock frequency of the power supply controller.

2. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator including:
a power supply controller for generating ON/OFF signals of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, wherein
the power supply system includes:
a computation amount detector for detecting a computation amount of the processor core;
a command generator for outputting a command value of a clock frequency of the power supply controller from a detection value of the computation amount; and
a clock generator for generating the clock frequency of the power supply controller upon receiving the command value, and
the power supply system controls the clock generator when a decrease of the computation amount is detected in the computation amount detector to lower the clock frequency of the power supply controller.

3. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator includes:
a power supply controller for generating ON/OFF signal of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, and
the power supply system includes:
a computation amount detector for detecting a computation amount of the processor core; and
a voltage command generator for generating a voltage command value of the processor core from a detection value of the computation amount, and
the power supply system lowers the clock frequency of the power supply controller when the power supply controller detects the voltage command value for lowering a voltage of the processor core.

4. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator including:
a power supply controller for generating ON/OFF signals of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, wherein
the power supply system includes:
a power consumption detector for detecting a power consumption of the processor core;
a command generator for outputting a command value of a clock frequency of the power supply controller from a detection value of the power consumption; and
a frequency divider for generating the clock frequency of the power supply controller upon receiving the command value, and
the power supply system controls the frequency divider when a decrease of the power consumption is detected in the power consumption detector to lower the clock frequency of the power supply controller.

5. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator including:
a power supply controller for generating ON/OFF signals of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, wherein
the power supply system includes:
a temperature detector for detecting a temperature of the processor core;
a command generator for outputting a command value of a clock frequency of the power supply controller from a detection value of the temperature; and
a frequency divider for generating the clock frequency of the power supply controller upon receiving the command value, and
the power supply system controls the frequency divider when a decrease of the temperature is detected in the temperature detector to lower the clock frequency of the power supply controller.

6. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator including:
a power supply controller for generating ON/OFF signals of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, wherein
the power supply system including:
an activation ratio detector for detecting a circuit activation ratio of the processor core;
a command generator for outputting a command value of a clock frequency of the power supply controller from a detection value of the circuit activation ratio; and
a frequency divider for generating the clock frequency of the power supply controller upon receiving the command value, and
the power supply system controls the frequency divider when a decrease of the circuit activation ratio is detected in the activation ratio detector to lower the clock frequency of the power supply controller.

7. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator including:
a power supply controller for generating ON/OFF signals of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, wherein
the power supply system includes:
a clock determiner for detecting a clock command value of the processor core;
a command generator for outputting a command value of a clock frequency of the power supply controller from the clock command value of the processor core; and
a frequency divider for generating the clock frequency of the power supply controller upon receiving a clock command value of the power supply controller, and
the power supply system controls the frequency divider when a decrease of the clock of the processor core is detected in the clock determiner to lower the clock frequency of the power supply controller.

8. A power supply system comprising:
a processor;
a switching regulator for supplying power to the processor;
means for varying each operation voltage and clock frequency of a plurality of processor cores of the processor; and
a battery to be an input direct-current voltage source of the switching regulator;
the switching regulator including:
a power supply controller for generating ON/OFF signals of a switching from at least 2 or more input values including a command value and a detection value of the each operation voltage of the plurality of processor cores; and
a voltage regulator for converting the input direct-current voltage source to a constant voltage upon receiving an output signal of the power supply controller, and then, supplying power to the processor, wherein
the power supply system includes:
a computation amount detector for detecting a computation amount of the plurality of processor cores;
a command generator for outputting a command value of a clock frequency of the power supply controller from a detection value of the arithmetic amount; and
a frequency divider for generating the clock frequency of the power supply controller upon receiving the command value, and
the power supply system detects a computation amount of a processor core having the largest computation amount among the plurality of processor cores, and
the power supply system controls the frequency divider when a decrease of the computation amount is detected in the computation amount detector to lower the clock frequency of the power supply controller.

9. A power supply system comprising:
a processor;
a switching regulator for supplying power to the processor;
means for varying an operation voltage and a clock frequency of a processor core of the processor; and
a battery to be an input direct-current voltage source of the switching regulator;
the switching regulator including:
a power supply controller for generating ON/OFF signals of a switching from at least 2 or more input values including a command value and a detection value of the operation voltage of the processor core; and
a voltage regulator for converting the input direct-current voltage source to a constant voltage upon receiving an output signal of the power supply controller, and then, supplying power to the processor, wherein
the power supply system includes:
a computation amount detector for detecting an arithmetic amount of the processor core;
a command generator for outputting a command value of a clock frequency of the power supply controller from a detection value of the arithmetic amount; and
a frequency divider for generating the clock frequency of the power supply controller upon receiving the command value, and
the power supply system controls the frequency divider when a decrease of the computation amount is detected in the computation amount detector to lower the clock frequency of the power supply controller and to lower a switching frequency of the switching regulator.
